(19) United States
(12) Patent Application Publication
(10) Pub. No.: US 2015/0148210 A1
(43) Pub. Date: May 28, 2015

(54) ASSEMBLY FOR CUSTOM BOX BLANK PREPARATION AND METHOD

(71) Applicant: SERVICES DE MARKETING SIBTHORPE INC., VILLE ST-LAURENT (CA)

(72) Inventor: Robert Sibthorpe, Baie d'Urfé (CA)

(21) Appl. No.: 14/406,362

(22) PCT Filed: Jun. 6, 2013
(86) PCT No.: PCT/CA2013/050433

§ 371 Date: Dec. 8, 2014

Related U.S. Application Data
(60) Provisional application No. 61/656,219, filed on Jun. 6, 2012.

(51) Int. Cl. B31B 1/88; B41J 3/407; B31B 1/20

(52) U.S. Cl. CPC B31B 1/88; B31B 1/20; B41J 3/407; B31B 2201/147; B31B 2201/88
USPC 493/324; 347/4

(57) ABSTRACT

An assembly for preparing a box blank from a cardboard sheet. The assembly comprises a feeder for vertically feeding one of a plurality of the cardboard sheets from a storage position into a printing/cutting assembly, the printing/cutting assembly comprising a printing station comprising at least one printer head and a vertical conveyor for conveying a printing surface of the cardboard sheet proximate to and past the at least one printer head, wherein the printing surface is printed by the at least one printer head during the conveying, and a cutting station. Each of the printer heads and each of the cutting blades is vertically moveable respectively into a selected printing position and a selected cutting position under control of a controller thereby accommodating a plurality of different cardboard sheets of different sizes.

### FIELD OF THE INVENTION

The present invention relates to an assembly and method for the preparation of custom box blanks. In particular, the present invention relates to an assembly for box preparation and related method that processes cardboard sheets as they are vertically conveyed for the printing, cutting, and creasing thereof to produce box blanks for subsequent assembly into boxes.

### BACKGROUND OF THE INVENTION

The prior art reveals a number of box blank preparation assemblies which provide an automated means of processing box blanks. Typically, for higher volume production processing of box blanks, cardboard sheets are horizontally fed and conveyed through one or more sequential horizontal processing stations including printing, slotting, and/or creasing stations. The prior art also reveals a number of assemblies for custom box blank preparation for lower volume production of box blanks. Such assemblies produce box blanks at a vertical or near vertical orientation of the cardboard sheets with vertically moveable cutters and scorers.

One drawback of these assemblies becomes apparent when custom box bank preparation requiring printing, creasing, and slotting as part of small batch box blank production is desired. For small to medium sized batch jobs, traditional printing techniques of box blanks employing flexography require large horizontally disposed rollers which process horizontally conveyed box blanks. Such assemblies take up valuable production plant real estate and are inefficient for smaller custom box blank preparation jobs as the large plates of flexo printing must be replaced between print jobs, which generally results in lengthy downtime of the assembly there between. While printing techniques such as inkjets and the like are ideal for smaller custom printing jobs, the prior art reveals that such printing techniques are either used on horizontally conveyed blanks or on already formed boxes, and not as part of a vertical conveyor box blank preparation system.

### SUMMARY OF THE INVENTION

In order to address the above and other drawbacks, there is provided an assembly for preparing a box blank from a cardboard sheet. The assembly comprises a feeder for vertically feeding one of a plurality of the cardboard sheets from a storage position into a printing/cutting assembly, the printing/cutting assembly comprising a printing station comprising at least one printer head and a vertical conveyor for conveying a printing surface of the cardboard sheet proximate to and past the at least one printer head, wherein the printing surface is printed by the at least one printer head during the conveying, and a cutting station comprising a feed mechanism for feeding the cardboard sheet into at least one cutting position and upper and lower elongate slot cutting blades arranged vertically and configured to cut respectively an upper slot and lower slot in the cardboard sheet when in the at least one cutting position, the feed mechanism subsequently ejecting the cut cardboard sheet from the cutting station. Each of the printer heads and each of the cutting blades is vertically moveable respectively into a selected printing position and a selected cutting position under control of a controller thereby accommodating a plurality of different cardboard sheets of different sizes.

There is also disclosed an assembly for printing substantially rigid cardboard sheets. The assembly comprises a feeder for vertically feeding one of a plurality of the cardboard sheets from a storage position into a printing station, the printing station comprising a vertical conveyor for conveying a printing surface of the cardboard sheet proximate to a plurality of inkjet printer heads spaced vertically, wherein the printing surface is printed as the cardboard sheet is conveyed vertically adjacent the plurality of printer heads. Each of the printer heads is vertically moveable respectively into a selected printing position under control of a controller thereby accommodating a plurality of different cardboard sheets of different sizes.

Also, there is provided a vertically moveable large character printer. The assembly comprises a threaded shaft arranged vertically and rotatably secured at both ends, an elongate stabilising member arranged adjacent and in parallel to the threaded rod, a support comprising an aperture complementarily threaded for receiving the threaded shaft therein, wherein a rotary movement of the support is prevented by the stabilising member, a large character printer head attached to the support and comprising a printing surface, wherein the printer head is aligned for printing a surface substantially in parallel to the shaft, and a motor for rotating the threaded shaft in selected direction. When the shaft is rotated by the motor, the support is free to move up and down a length of the shaft in accordance with the selected direction of rotation.

### BRIEF DESCRIPTION OF THE DRAWINGS

FIG. 1 is a assembly diagram of a custom box blank assembly in accordance with an illustrative embodiment of the present invention;

FIG. 2 is a front side view of the custom box blank assembly in accordance with an illustrative embodiment of the present invention;

FIG. 3 is a raised left perspective view of a feeding station of the custom box blank assembly of FIG. 2;

FIG. 4 is a detailed perspective view of the underside of a feeding station of the custom box blank assembly of FIG. 2;

FIG. 5 is a raised left perspective view of a printing station of the custom box blank assembly of FIG. 2;

FIG. 6 is a raised right partial perspective view of the printing station of FIG. 5;

FIG. 7 raised left perspective view of a cutting station of the custom box blank assembly of FIG. 2;

FIG. 8 is a raised left partial perspective view of the cutting station of FIG. 7;

FIGS. 9a and 9b are schematic views of a cutting station respectively in accordance with an illustrative embodiment and an alternative illustrative embodiment of the present invention;

FIGS. 10a through 10d provide partial side plan views of the cutting station of FIG. 7; and

FIG. 11 provides a left rear perspective view of the cutting station of FIG. 7.

### DETAILED DESCRIPTION OF THE ILLUSTRATIVE EMBODIMENTS

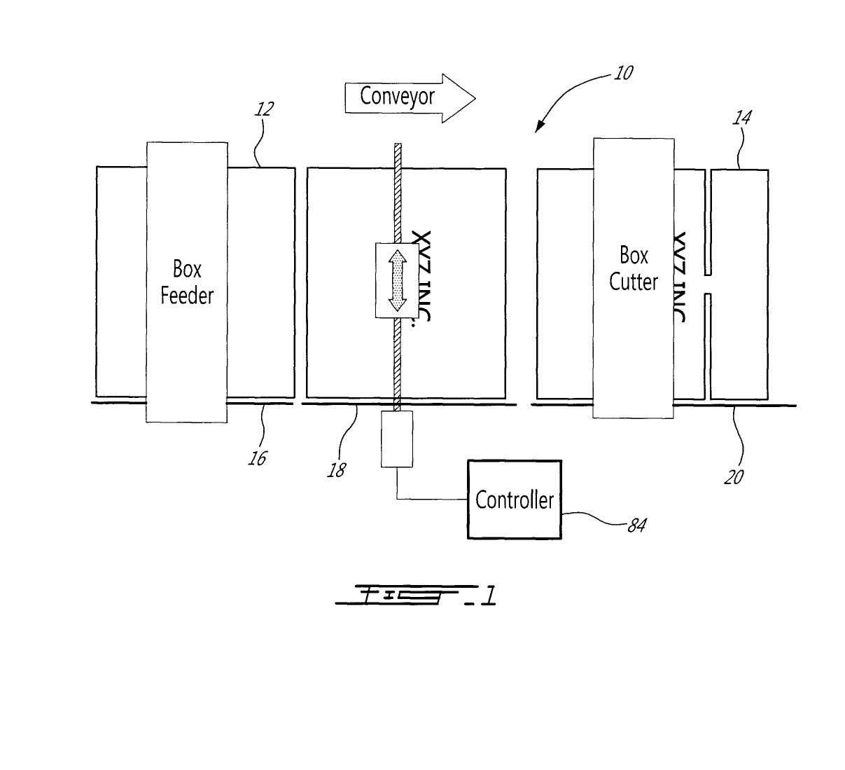

Referring now to FIG. 1, a custom box blank system, generally referred to using the reference numeral 10, will now be described. The custom box blank assembly 10 serves to process a cardboard sheet as in 12 for the printing, cutting, and creasing thereof as part of the production of a box blank 14 to be subsequently formed into a slotted container as is generally known in the art. As illustrated, the custom box blank assembly 10 comprises several cardboard sheet processing stations in sequential arrangement which process a vertically oriented cardboard sheet as in 12 as it is conveyed from station to station. Of note, while reference is made to the processing of a cardboard sheet as in 12, other types of corrugated fiberboard or the like may be processed by the custom box blank assembly 10.

Still referring to FIG. 1, in accordance with an exemplary illustrative embodiment of the present invention, the custom box blank assembly 10 comprises a feeding station 16, a printing station 18, and a cutting station 20 which serially processes a cardboard sheet as in 12 as it is conveyed from one station to the next in a manner described herein below. Advantageously, the vertical processing of the cardboard sheet as in 12 into a box blank 14 provides an assembly comprising a reduced plant floor footprint that is ideal for the preparation of small to medium sized box blank custom preparation jobs.

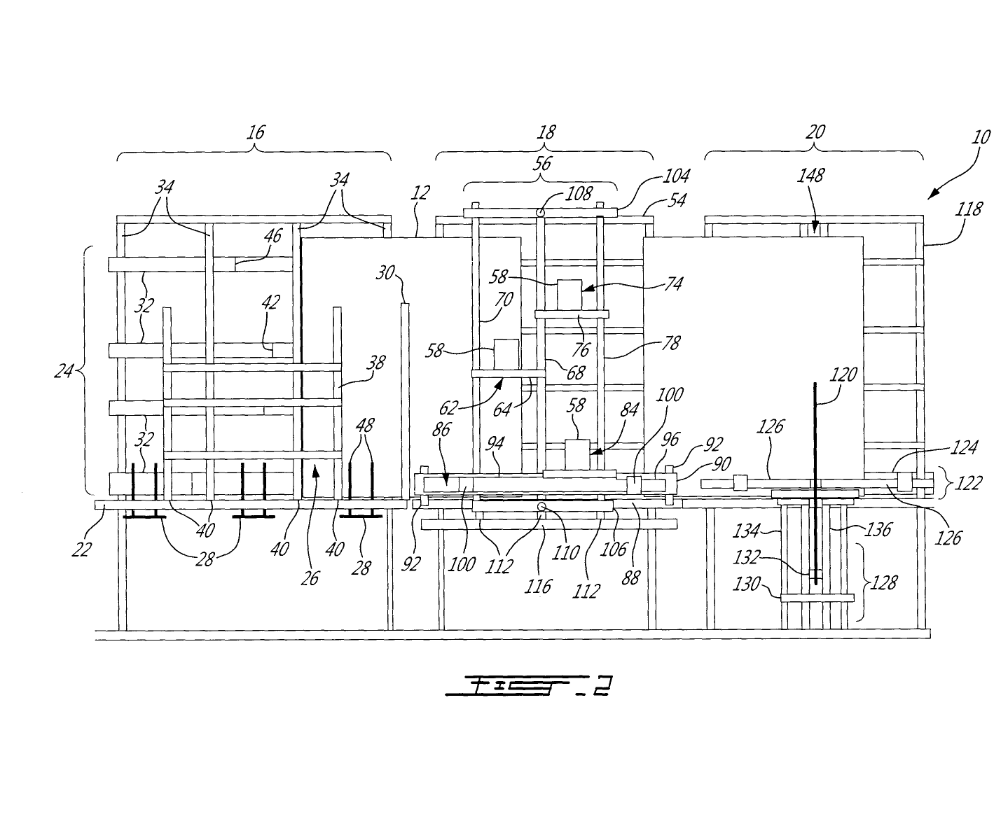

Now referring to FIG. 2, in addition to FIG. 1, the cardboard sheet as in 12 is conveyed between the feeding station 16, the printing station 18, and the cutting station 20 which are positioned adjacent to one another. Conveyors provided for on each station operate independently of one another and are aligned such that the cardboard sheet as in 12 is seamlessly handed off to the next subsequent station.

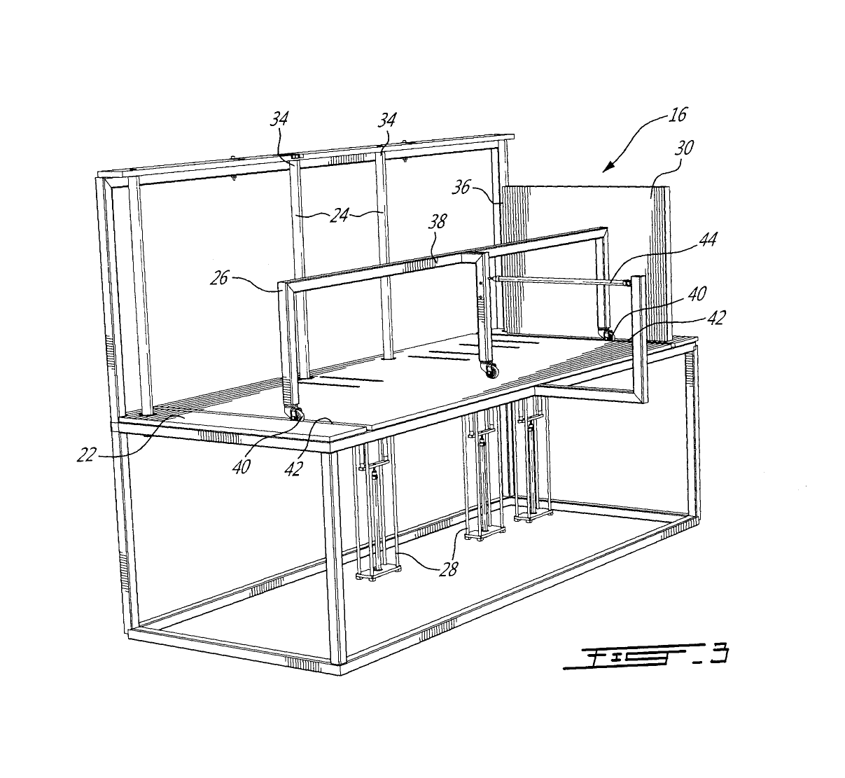

Now referring to FIG. 3, in addition to FIG. 2, the feeding station 16 illustratively holds one or more cardboard sheets as in 12 as a stacked plurality of cardboard sheets that are to be supplied to the subsequent stations for processing. The feeding station 16 comprises a loading platform 22 for supporting the edges of the cardboard sheets as in 12 when vertically stacked thereon, a feeding conveyor 24 for frictionally engaging the surface of the cardboard sheet as in 12 and conveying the cardboard sheets as in 12 from the stack to the subsequent station, and a primary pressure assembly 26 for ensuring that a first one of the stack of cardboard sheet as in 12 enters with and remains in contact with the feeding conveyor 24 during feeding. There is also provided one or more secondary pressure assemblies as in 28 for ensuring that a sufficient pressure is maintained upon the stack of cardboard sheets as in 12 during a refilling of the feeding station 16, and a stop 30 for controlling the serial feeding of cardboard sheets as in 12 to the printing station 18.

Still referring to FIG. 2 and FIG. 3, when a cardboard sheet as in 12 enters into frictional contact with the feeding conveyor 24, it will be moved from the stack and to the printing station 16 at a rate and direction according to the speed and direction of the feeding conveyor 24. Illustratively, the feeding conveyor 24 comprises a plurality of feeding belts as in 32 positioned in the vertical horizon parallel to the cardboard sheets as in 12 to provide a frictional surface for which to engage the cardboard sheets as in 12. The movement of the feeding belts as in 32 is occasioned by the rotation of one or more powered pulleys as in 34 also positioned in the vertical plane and around which the feeding belts as in 32 loop. The feeding belts as in 32 are illustratively formed of a rubber material or the like as is generally known in the art to provide a sufficient frictional surface for engaging the paper like material of the cardboard sheets as in 12. The pulleys as in 34 may be powered by an electric, hydraulic, pneumatic or other motor (not shown) occasioning their rotation.

Still referring to FIG. 2 and FIG. 3, to ensure that cardboard paper sheets as in 12 are fed in a sequential manner from the feeding station 16, that is one cardboard sheet as in 12 serially supplied to the printing station 18 a time, the stop 30 is adjusted in the horizontal direction relative to the feeding conveyor 24 to thereby adjust the width of a vertical feeding gap 36 between the plane of the feeding conveyor 24 and the stop 30 to thereby control the supply of cardboard sheets as in 12 from the feeding station 16 to the printing station 18. This adjustment allows the custom blank assembly 10 to accommodate cardboard sheets as in 12 of different thicknesses or gauges by allowing only a single cardboard sheet as in 12 to be nudged by the feeding conveyor 24 and through the feeding gap 36 at any given moment. Illustratively, the stop 30 is adjustable by the actuation of a worm gear coupling the stop 30 to the loading platform 22, or by any other like manner that is generally known in the art.

Still referring to FIG. 2 and FIG. 3, to ensure that the cardboard sheet as in 12 remains in frictional contact with the feeding conveyor 24, the primary pressure assembly 26 applies a distributed pressure to the stack of cardboard sheets as in 12 during feeding. Illustratively, the primary pressure assembly 26 comprises a frame assembly 38 capable of evenly distributing the pressure applied to the surface of the cardboard sheet as in 12 positioned on the loading platform 22. The primary pressure assembly 26 is able to be displaced in a horizontal direction perpendicular to the vertical plane of the feeding conveyor 24 as cardboard sheets as in 12 are removed from the stack during operation of the feeding conveyor 24 in order to maintain a pressure applied to the stack required for the feeding belts as in 32 to frictionally engage the cardboard sheets as in 12. Illustratively, the primary pressure assembly 26 is provided on a plurality of wheels 40 guided by a plurality of slots 42 into which the plurality of wheels 40 engage and are guided by. An actuator 44, such as a linear hydraulic actuator or the like is provided to force the primary pressure assembly 26 into and out of contact with the stacked cardboard paper sheets as in 12 to thereby maintain an applied pressure thereto. During a refilling of the feeding station 16, the actuator is able to retract the primary pressure assembly 26 to allow additional cardboard paper sheets as in 12 to be loaded onto the loading platform 22. Additionally, to ensure a sufficient frictional contact of the feeding belts as in 32 with the cardboard sheet as in 12 as the pressure is applied by the primary pressure assembly 26, there may be illustratively provided raised protrusions 46 on the feeding belts as in 32 to engage the cardboard sheets as in 12.

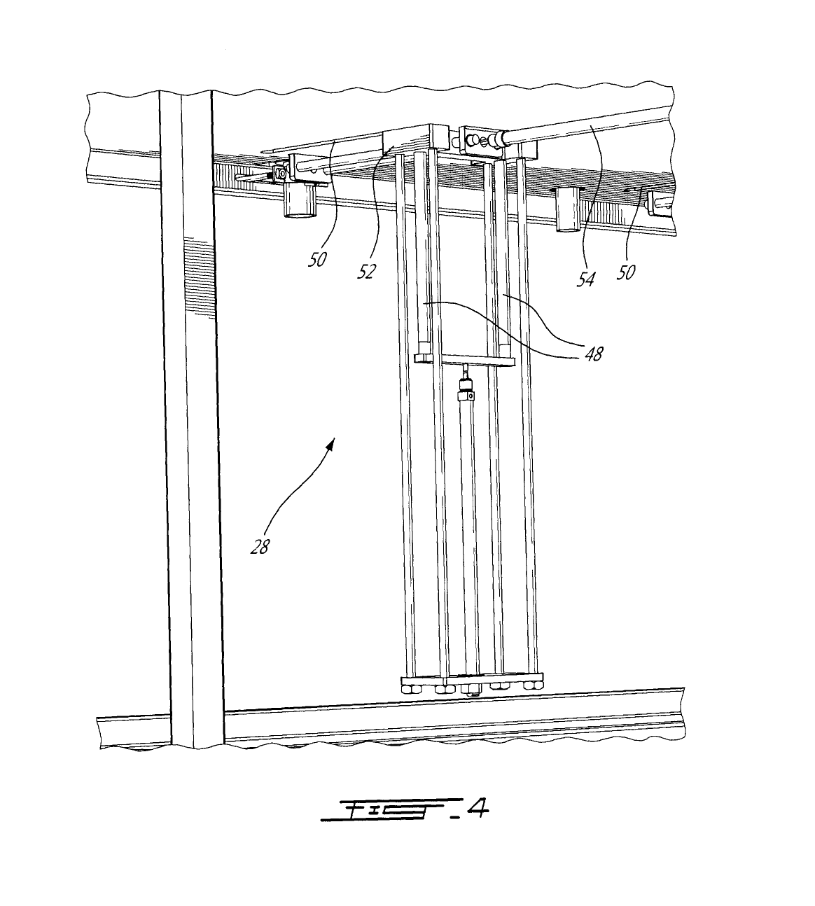

Referring to FIG. 4 in addition to FIG. 2, to ensure that the feeding station 16 is able to continuously supply cardboard sheets as in 12 to the printing station 18, the secondary pressure assemblies as in 28 maintain the pressure on a reduced cardboard sheet stack during refilling of the feeding station 16. Illustratively, the secondary pressure assemblies as in 28 are able to replace the application of pressure on the stack applied by the primary pressure assembly 26 to thereby allow the primary pressure assembly 26 to be retracted such that additional cardboard sheets as in 12 can be refilled on the loading platform 22. Each of the secondary pressure assemblies as in 28 comprises two pressure bars 48 slidable upwardly from a position beneath the loading platform 22 through apertures as in 50 provided in the loading platform 20 and to an extracted position whereby the pressure bars 48 engage the surface of the cardboard sheet as in 12. To compensate for the removal of cardboard sheets as in 12 from the stack by the feeding conveyor 24 causing a reduction in the width of the stack, the pressure bars 48 are mounted to a sliding assembly 52 affixed to the underside of the loading platform 22 which allows a horizontal movement of the pressure bars 48 within the apertures as in 50 to thereby maintain a constant and sufficient pressure on the diminishing stack. The movement of both the pressure bars 48 and the siding assembly 52 may be occasioned by the activation of a linear actuator 54 connected to the sliding assembly 52 in a manner that is generally known in the art.

Still referring to FIG. 2 and FIG. 4, the one or more secondary pressure assemblies as in 28 may be provided along the length of the loading platform 22 to evenly distribute the application of pressure to the cardboard sheets as in 12. During a refilling operation of the feeding station 16, the secondary pressure assemblies as in 28 move upwardly from their retracted state beneath the loading platform 22 to wedge between cardboard sheets as in 12 forming the diminishing stack and then horizontally within the apertures as in 50 towards the feeding conveyor 24 to force the cardboard sheets as in 12 in contact therewith. At this point, the primary pressure assembly 26 may be retracted from engagement with the stack by the actuator (not shown) to define a refill area between the primary pressure assembly 26 and the secondary pressure assemblies as in 28. Once the additional cardboard sheets as in 12 have been placed in this refill area, the primary pressure assembly 26 is reengaged to enter into contact with the diminished stack and the secondary pressure assemblies as in 28 are retracted.

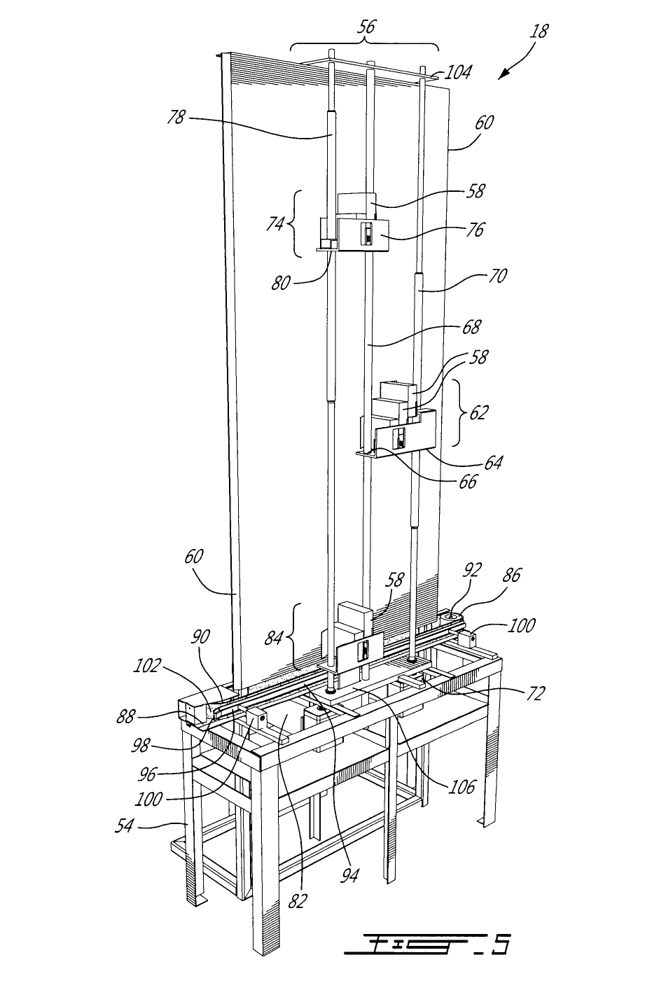

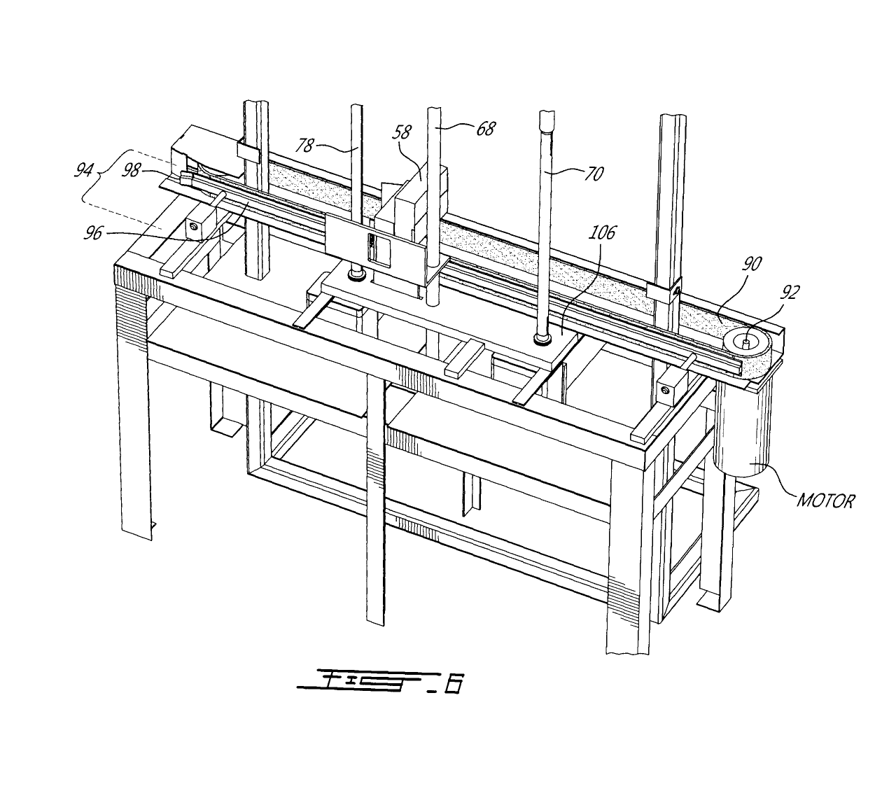

Now referring to FIG. 5 and FIG. 6 in addition to FIG. 2, cardboard paper sheets as in 12 that are supplied to the printing station 18 are conveyed through this station so that matter may be printed thereon. In accordance with an illustrative embodiment of present invention, the printing station 18 comprises a frame 54 vertically disposed for supporting a printing assembly 56 movable in the horizontal plane towards and away from the surface of the cardboard sheet as 12 as it is conveyed past printer heads as in 58 affixed to the printing assembly 56. The frame 52 also serves as a backing to support for panelling 60 which supports the cardboard sheet as in 12 as it is conveyed past the printer heads as in 58. Illustratively, the frame 52 may be constructed from hollow tube framing of aluminium or steel. Illustratively, the printer head 58 is a large character ink jet type printer head.

Still referring to FIG. 2, FIG. 5 and FIG. 6, a first printer head assembly 62 provided on the printing assembly 56 is slidably moveable in the vertical plane parallel to the cardboard sheet as in 12. Illustratively, the first printer head assembly 62 comprises a first bracket 64 on which one or more printer heads as in 58 are mounted. Illustratively, the printer heads as in 58 are mounted to the first bracket 64 using a biasing means such as a spring (not shown) which forces the printer head against the cardboard sheet 12 as it is conveyed past. Also illustratively, three printer heads as in 58 are provided on the first bracket 64 at offset positions to increase the area of printing by the printer heads affixed thereto. The first bracket 64 comprises a first aperture 66 for receiving a vertically positioned stabalising guide rail 68 to provide stabilised vertical sliding movement of the first printer head assembly 62. The first bracket 64 further comprises a threaded aperture (not shown) for receiving therein a vertically positioned first endless screw 70 therein, a rotation of which translates into a vertical displacement of the first printer head assembly 62. Illustratively, the rotation of the first endless screw 70 is occasioned by an electric motor 72 or the like provided at one end thereof. In accordance with an illustrative embodiment of the present invention, a second printer head assembly 74 may be provided adjacent to the first printer head assembly 62 which further comprises a second bracket 76 for receiving a second endless screw as in 78 through a threaded aperture 80 and which slidably receives the stabalising guide rail 68 through a second aperture (not shown). Illustratively, the rotation of the second endless screw 78 is occasioned by a second electric motor 82 or the like provided at one end thereof. Illustratively, two printer heads as in 58 are provided on the second bracket 76 at offset positions to increase the area of printing by the printer heads affixed thereto. There may also be provided a fixed printer head assembly 84 which remains fixed to the printing assembly 62 to provide for the printing of material at a same position on the cardboard sheet as in 12 as it is conveyed thereby.

Now referring back to FIG. 1, in addition to FIG. 2, FIG. 5 and FIG. 6, the printer heads as in 58 comprise an ink jet or spray jet printer head as is generally known in the art capable of depositing ink onto the surface of the cardboard sheet as 12 as it is conveyed thereby. Advantageously, the first and second movable printer head assemblies as in 62, 74 provide flexibility for the printing of material at different positions onto the cardboard sheet as in 12. Such a positioning is controlled by a programmable controller which controls the position of the printer head assemblies 62, 74 through the actuation of their respective motors as in 72, 82 occasioning rotation of the endless screws as in 70, 78 for vertically upward or downward movement of the assemblies 62, 74. Such positioning of the first and second printer head assemblies 62, 74 can be done independently of each other as each assembly's position is controlled by the independently rotatable endless screws 70, 78. During the printing of material onto a conveyed cardboard sheet as in 12, the first printer head assembly 62 and the second printer head assembly 74 remain motionless. It is only between setup of different custom print jobs that the vertical position of the printer head assemblies 62, 74 is varied. Illustratively, the fixed printer head assembly 84 may provide for the printing of a logo onto the cardboard sheet as in 12, while the other two printer heads assemblies 62, 74 may deposit complementary information. Of note, while three separate printer head assemblies have been illustrated, additional printer head assemblies and independently rotatable endless screws may be provided.

Still referring to FIG. 2, FIG. 5 and FIG. 6, the cardboard sheet as in 12 received from the feeding station 16 is conveyed through the printing station 18 and past the printer heads as in 58 by a second feeding conveyor 86 provided for at the base of the printing station 16. The second feeding conveyor 86 engages the lower end of the cardboard sheet as in 12 as it rests upon a printing platform 88 and comprises a second conveyor belt 90 looped around one or more second powered pullies as in 92 whose rotation occasions the movement of the second conveyor belt 90 in a manner that is generally known in the art.

Still referring to FIG. 2, FIG. 5 and FIG. 6, to ensure that the second conveyor belt 90 is frictionally engaged with the cardboard sheet as in 12, a pressure plate assembly 94 is provided opposite the second conveyor belt 90 to thereby force the cardboard sheet as in 12 into frictional engagement with the second conveyor belt 90 as it is conveyed thereby in a similar manner as the primary pressure assembly 26 forces the stack of cardboard paper sheets as in 12 into contact with the feeding conveyor 24. Illustratively, the pressure plate assembly 94 comprises an elongated member 96 of substantially the same height as the oppositely positioned second conveyor belt 90 and may be fabricated from metal or the like and which comprises a frictionless plastic guiding surface so that cardboard sheets as in 12 are unhindered by its engagement therewith. Arcuate ends 98 provided at the ends of the pressure plate assembly 78 deflecting away from the second conveyor belt 90 ensure that cardboard sheets as in 12 are properly received and guided between the second conveyor belt 90 and the pressure plate assembly 94 when supplied from the feeding station 16.

Still referring to FIG. 2, FIG. 5 and FIG. 6, in order to actuate the horizontal movement of the pressure plate assembly 94 towards the second conveyor belt 90 such that the cardboard sheet as in 12 is in sufficient in frictional contact with the conveyor belt to occasion its conveyance past the printer heads as in 58, linear actuators as in 100 such as hydraulic or screw actuators are connected to the back of pressure plate assembly 94 to generate the pressure and the horizontal movement of the pressure assembly plate assembly 94 towards or away the second conveyor belt 90. Additionally, there may be provided a plurality of second protrusions as in 102 extending from the second conveyor belt 90 to ensure that it sufficiently frictionally engages the cardboard sheet as in 12 and that there is no slippage as the cardboard sheet as in 12 is conveyed.

Still referring to FIG. 2, FIG. 5 and FIG. 6, advantageously, the vertical movable printer heads as in 58 allow different sized cardboard sheets as in 12 to be printed thereon. To accommodate cardboard sheets as in 12 of various widths, the printing assembly 56 comprising the printer head assemblies 62, 74 and 84, the stabalising guide rail 68 and the endless screws 70, 78, is horizontally movable relative to the frame 54 to adjust the distance of the printer heads as in 58 from the surface of the cardboard sheet as in 12. As known in the art, cardboard sheets as in 12 to be subsequently formed into boxes may require printing at three (3) different locations. For example, the middle region of the blank, covered by the second printer assembly 74 would typically be used to print large company logos and other information descriptive of the box's content. The first and third printer assemblies 62, 84 on the other hand which are positioned in operation towards the outer edges of the cardboard sheet(s) as in 12, would typically be used to print barcode and certification information.

Illustratively, the ends of the stabalising guide rail 68 and the first and second endless screws 70, 78 are mounted between an upper plate 104 and a lower plate 106 which are mounted at the top and bottom ends of the frame 54 respectively via a horizontally configured endless screw and nut configuration. In particular, there is provided a third endless screw 108 and a fourth endless screw 110 which engage threaded apertures (not shown) horizontally disposed within the upper plate 104 and the lower plate 106. The rotation of the third and fourth endless screws 108, 110 is occasioned by an actuator, such as an electric motor (not shown) or the like in a manner that is generally known in the art. Upon rotation of the third and fourth endless screws 108, 110, the upper and lower plates 104, 106 will be horizontally displaced either towards or away from the frame 54. Illustratively, the lower plate 104 comprises one or more wheels 112 affixed thereto which engage in and are guided by grooves 114 provided for in the support platform 116. The horizontal adjustment of the printing assembly 56 enables the printing of variable width cardboard sheets as in 12 as depending on the custom print job. The horizontal adjustment of the printing assembly 56 is controlled by the simultaneous adjustment of the position of the upper and lower plates 104, 106 to ensure that the printer heads as in 58 remain at a perpendicular angle to the surface of the cardboard sheet as in 12, as offset angles could cause a degradation in the printing quality.

Still referring to FIG. 2, FIG. 5 and FIG. 6, a plurality of sensors (not shown) are provided to determine the vertical position of the printer heads as in 58 in real time, for instance by reading a graduated stabilising guide rail 68. Additionally, one or more sensors may be provided to measure the horizontal displacement in real time of the cardboard sheets as in 12 as they are conveyed past the printer heads as in 58 to ensure that the printing produces suitable results, in that the cardboard sheet as in 12 is not conveyed too quickly nor too slowly past the printer heads as in 58. Accordingly, the translation of the second conveyor belt 90 may thus be corrected and controlled in real time to ensure such a quality printing.

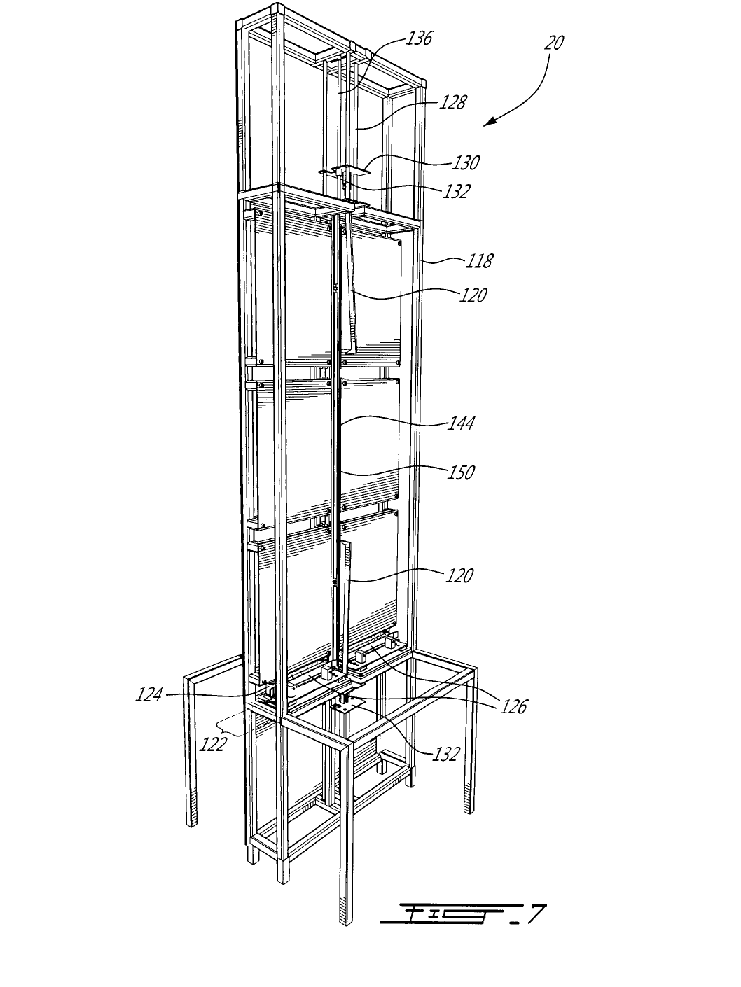

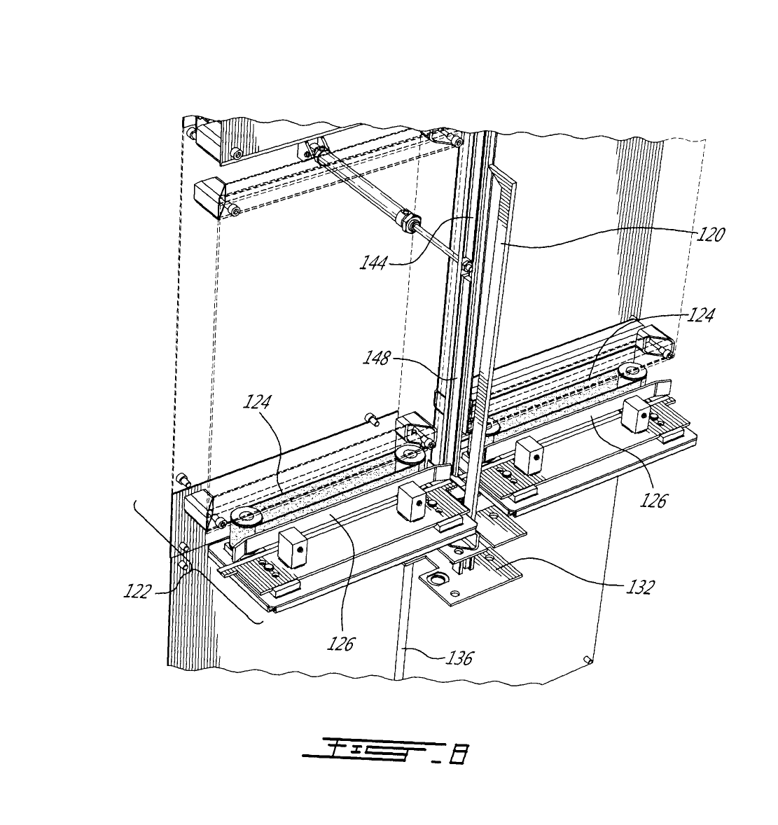

Now referring to FIG. 7 and FIG. 8 in addition to FIG. 2, once the cardboard sheet as in 12 has been processed by printing matter thereon, the second conveyor belt 90 will feed the printed cardboard sheet as in 12 to the next processing station, illustratively the cutting station 20. The cutting station 20 provides for the slotting and cutting of the cardboard sheet as in 12 required to produce the flaps for folding the cardboard sheet as in 12 into a box. The cutting station 20 illustratively comprises a panelled frame 118 for vertically supporting the cardboard sheet as in 12 during cutting and slotting thereof by a pair of cutting blades as in 120 (note that FIG. 2 only shows a single cutting blade, although a pair are typically provided). Additionally, there is provided a cutting conveyor assembly 122 comprising a pair of conveyor belts as in 124 and a pair of second pressure plate assemblies 126 similar to the second conveyor belt 90 and pressure plate assembly 96 provided for the printing station 18. The pressure plates 126 maintain the cardboard sheet 12 in frictional contact with conveyor belts as in 124 ensuring that the cardboard sheet 12 is transported correctly through the cutting station 20.

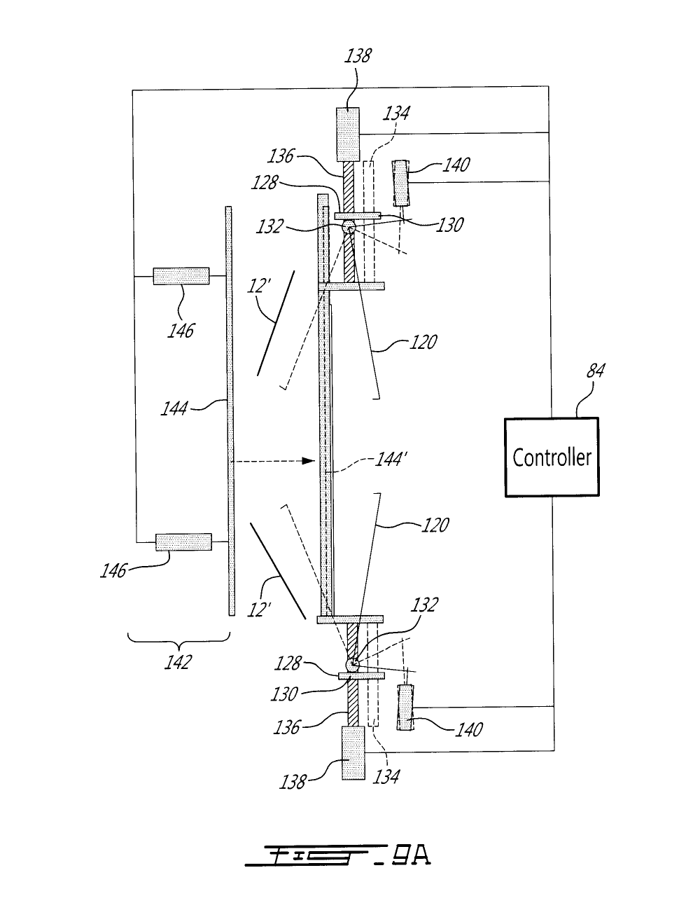

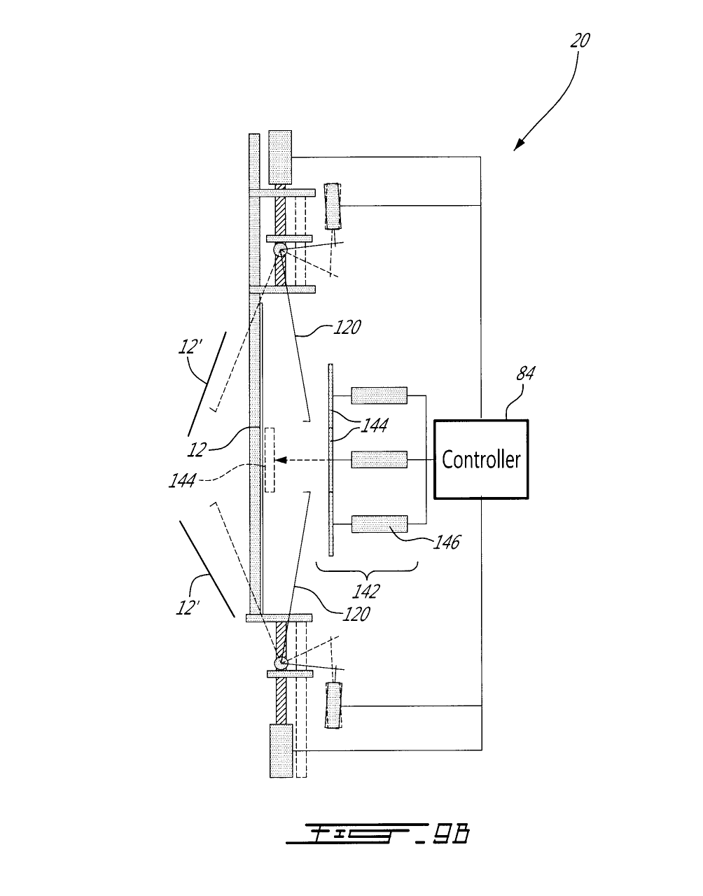

Referring to FIG. 9a in addition to FIG. 2, FIG. 7 and FIG. 8, as the cardboard sheet as in 12 is conveyed through the cutting station 20, it is conveyed past a pair of opposed cutting blades as in 120 positioned respectively at the bottom and at the top of the cutting station 20 which arch or swing into contact with the cardboard sheet as in 12 for cutting thereof. The cutting blades as in 120 are each provided for as part of independently vertically movable cutter assemblies as in 128 and which are each pivotally mounted to a respective movable cutter platform as in 130 about a pivot point as in 132. A vertical movement of the cutter platforms as in 130 adjusts the positioning of the respective cutting blade as in 120 relative to the cardboard sheet as in 12. The movement of the movable cutter platform as in 130 is occasioned by a rail and endless screw configuration similar to that employed to position the printer heads as in 58 described hereinabove. In particular, there is provided one or more vertically positioned guide rails as in 134 slidably received by the movable cutter platform as in 130 and a vertically positioned endless screw as in 136 received by a slotted aperture in the movable cutter platform as in 130 such that the rotation of the endless screw as in 136 occasioned by the actuation of an electric motor 138 or the like translates into an upward or downward vertical movement of the movable cutter platform as in 130, and thus the cutting blade as in 120.

Still referring to FIG. 2, FIG. 7, FIG. 8 and FIG. 9a, once the vertically movable cutter assemblies as in 128 have been positioned at controlled positions, the cutting blades as in 120 are pivoted about their respective pivot points as in 132 by the activation of an electric, pneumatic or hydraulic actuators as in 140 coupled thereto in a manner that is generally known in the art. This occasions the arching or swinging of the cutting blades as in 120 into contact with the cardboard sheet as in 12 such that small elongate cut-away portions as in 12′ of the box are removed. Following cutting, the blades as in 120 are returned to their unpivoted position, for example by deactivation of an electric or hydraulic actuators as in 120, thereby allowing the cut cardboard sheet as in 12 to be advanced to a subsequent cutting position as determined by the controller system 84, or ejected from the machine. Additionally, the movable cutter platforms as in 130 can then be moved vertically upwardly or downwardly in order to vary the length of the slots resultant of the cutting action.

Still referring to FIG. 9a, additionally, a creasing assembly 142 comprising a creasing element 144 can be actuated, for example through provision of a respective actuating valve(s) as in 146 or the like, to move the creasing element 144 from a retracted position to a creasing position (144′). As known in the art, creasing the cardboard sheet as in 12 in this manner provides readily bendable regions allowing for accurate folding of the cardboard sheet as in 12 into a box. Additional creasing elements (not shown), such as creasing wheels, can be arranged horizontally in order to crease the cardboard sheet horizontally as it is conveyed through the cutting station 20.

Referring to FIG. 9b, in an alternative embodiment, the creasing assembly 142 can be positioned behind the cutting blades 120 and actuated simultaneously therewith. In this regard, the one or more creasing elements as in 144 are actuated by a respective actuating valve as in 146 to move the creasing element 144 from a retracted position to a creasing position (144′) and follow the cutting blades 120 as they cut the cardboard sheet 12. In this embodiment, selection of the number of creasing elements 144 depends on the length of the crease to be formed as well as the relative distance between the ends of the cutting blades as in 120.

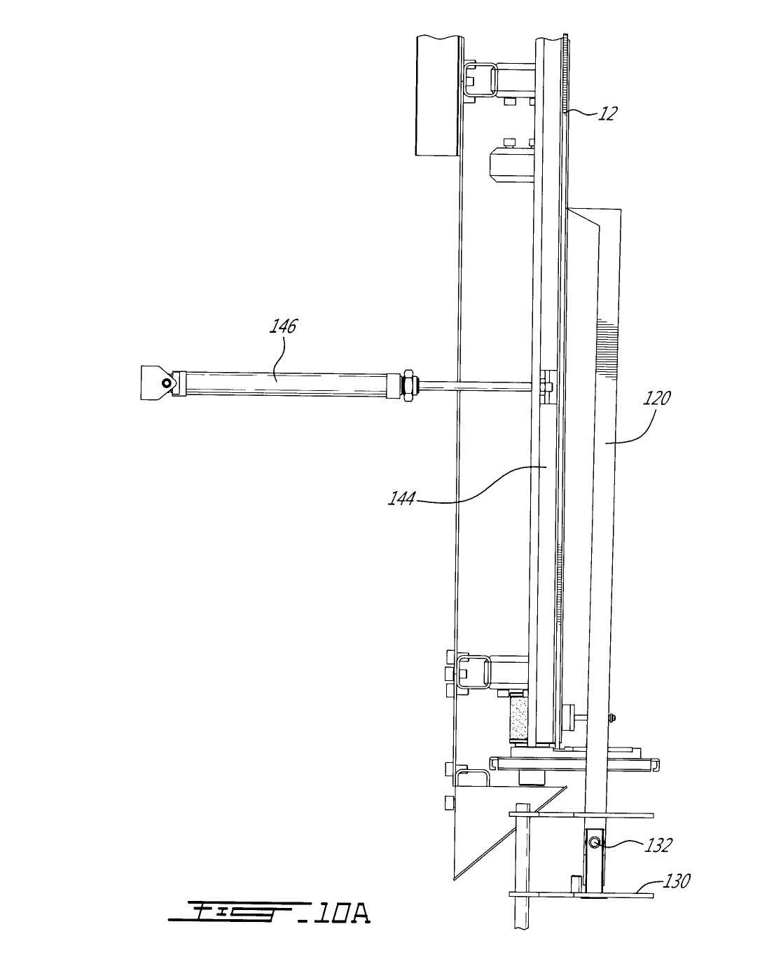

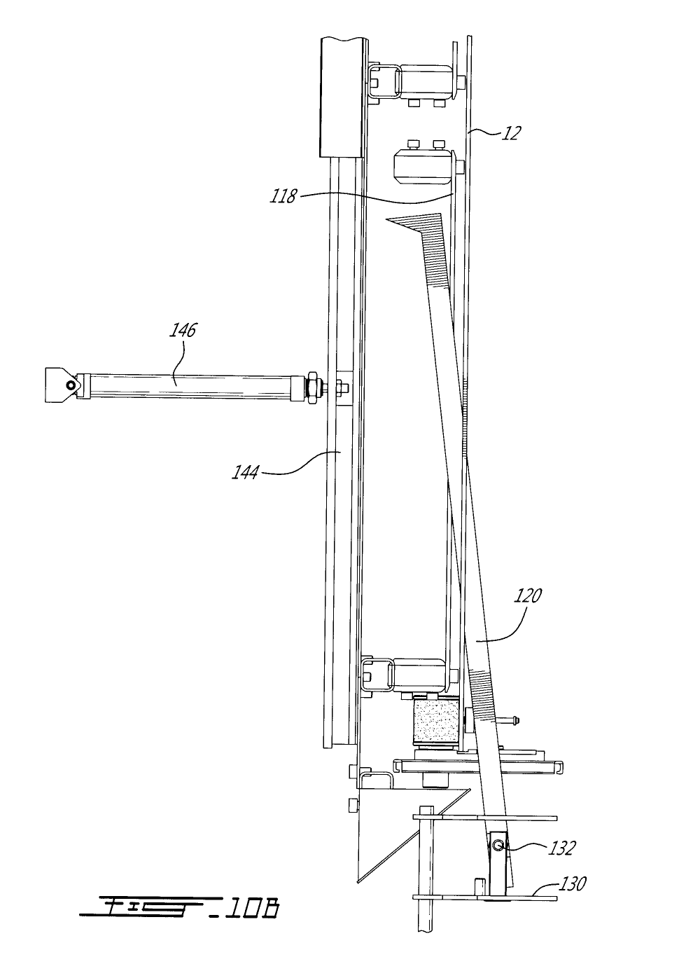

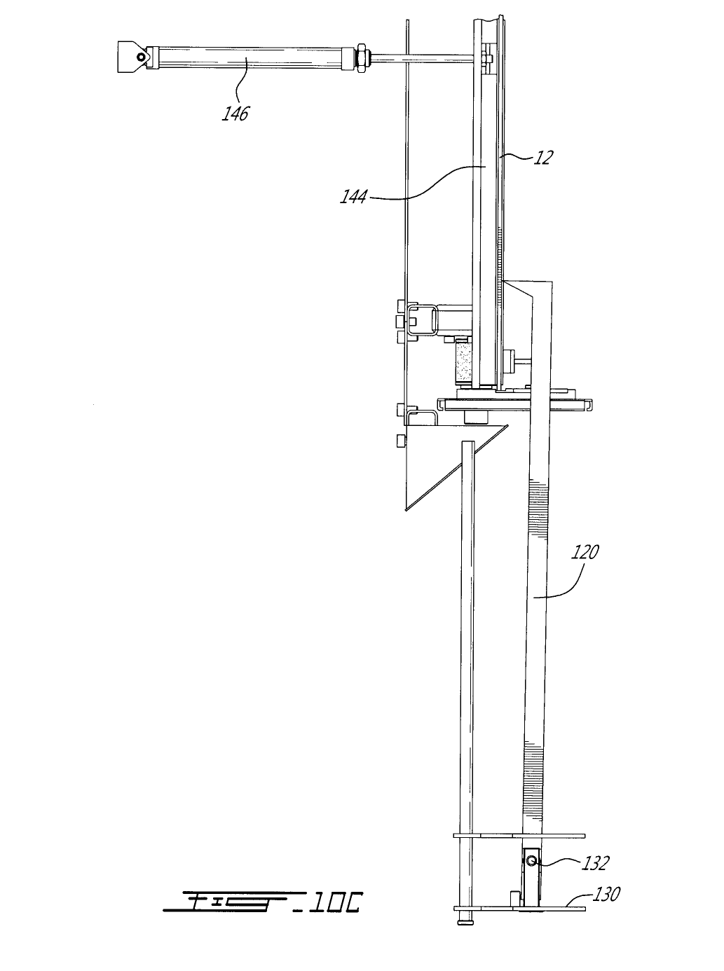

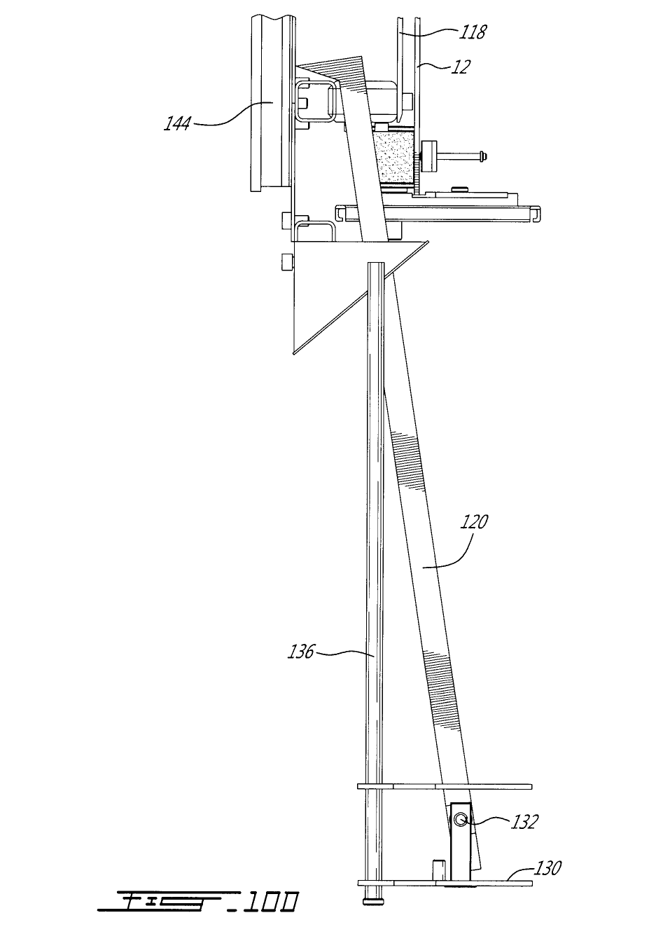

FIGS. 10a through 10d detail the cutting action of the cutting blade 120 in a first position (FIGS. 10a and 10b) and a second (lower) position (FIGS. 10c and 10d). During cutting of the cardboard sheet 12, the creasing element 144 is retracted using the valve 146 and the cutting blade 120 pivots about the pivot point 132. As discussed above the cutting blade 120 can be raised or lowered moved the first position (FIGS. 10a and 10b) to the second position (FIGS. 10c and 10d) and back to the first or any intermediate position by rotating the endless screw 136 in an appropriate direction.

Referring back to FIG. 7 and FIG. 8, there is provided a gap 148 between the pair of cutting conveyor belts 124 and the pair of second pressure plates assemblies 126 and in the panelled frame 118 to provide unhindered passage of the cutting blades as in 120 there through during cutting or slotting of the cardboard sheet as in 12.

Now referring back to FIG. 2 in addition to FIG. 7 and FIG. 8, the panelled frame 118 comprises a slot 150 which allows passage of the cutting blades as in 120 during their engagement with the cardboard sheet as in 12. The slot 150 is of similar width to that of the cutting blades as in 120 to ensure that the cardboard sheet as in 12 is not deformed from the pressure applied by the blades as in 120.

Still referring to FIG. 2 and FIG. 7, during the cutting or slotting process, the cardboard sheet as in 12 is held in place by pressure applied by the cutting conveyor assembly 122 which holds the cardboard sheet as in 12 in place. To effectuate additional cuts after the cutting blades as in 120 have passed through the cardboard sheet as in 12, the cutting blades as in 120 are retracted and the cutting conveyor assembly 122 is activated to displace the cardboard box as in 12 to a next cutting position and the process is repeated as many times necessary to produce the desired box blank 14. Slotting and cutting is thus performed in a sequential manner as the cardboard sheet as in 12 is vertically conveyed through the cutting station 20. Of note, during the slotting or cutting process, the cutting conveyor assembly 122 is deactivated to thereby immobilize the cardboard sheet as in 12. During this time the previous processing stations are also controlled to immobilize the cardboard sheets as in 12 in conveyance or at least ensure that a cardboard sheet as in 12 is not fed to the cutting station 20 such that the cutting process is interfered with.

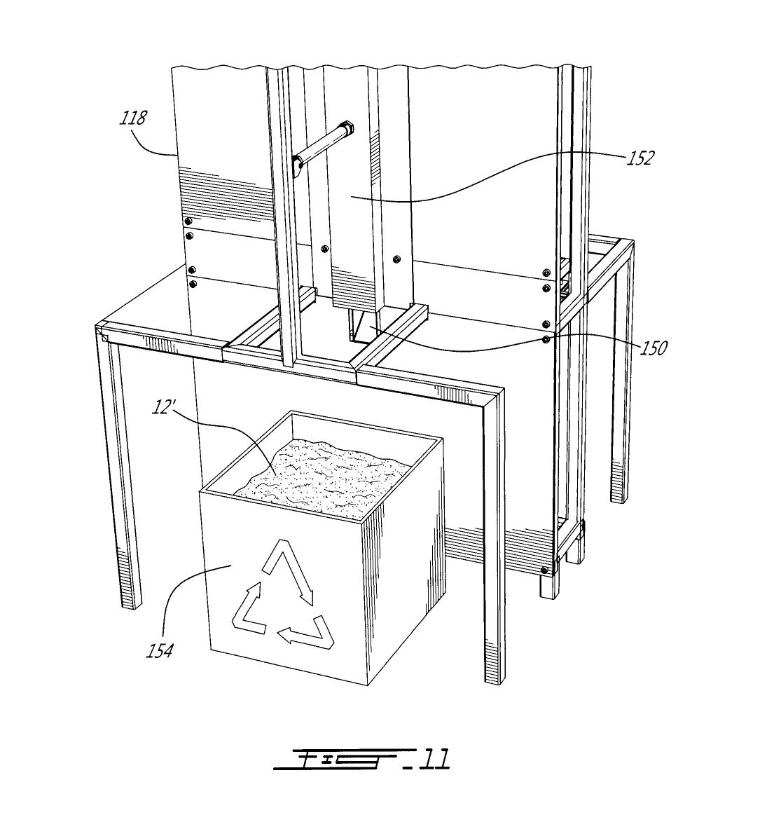

Now referring to FIG. 11 in addition to FIG. 2, as discussed above, a slot 150 in the rear of the panelled frame 118 is further provided for the passage of cardboard paper cuttings 12′ (see FIG. 7) to pass through and be collected in a vertical channel 152 provided at the rear of the panelled frame 118 (and running the length of the panelled frame 118) and guided into a waste basket 154 under the force of gravity or a vacuum.

While the sequences of processing of the cardboard box as in 12 have been described hereinabove in an ordered sequential manner, various combinations of stations and sequences may also be provided. For instance, it may be desired to cut the cardboard sheet as in 12 at a cutting station prior to printing the cardboard sheet as in 12. In a particular embodiment, additional printing stations 16 and/or cutting stations 18 could be added.

Although the present invention has been described hereinabove by way of embodiments thereof, it may be modified, without departing from the nature and teachings of the subject invention as defined in the appended claims.

What is claimed is:

1. An assembly for preparing a box blank from a cardboard sheet comprising:
a feeder for vertically feeding one of a plurality of the cardboard sheets from a storage position into a printing/cutting assembly;
said printing/cutting assembly comprising:
a printing station comprising at least one printer head and a vertical conveyor for conveying a printing surface of the cardboard sheet proximate to and past said at least one printer head, wherein the printing surface is printed by said at least one printer head during said conveying; and
a cutting station comprising a feed mechanism for feeding the cardboard sheet into at least one cutting position and upper and lower elongate slot cutting blades arranged vertically and configured to cut respectively an upper slot and lower slot in the cardboard sheet when in said at least one cutting position, said feed mechanism subsequently ejecting the cut cardboard sheet from said cutting station;
wherein each of said printer heads and each of said cutting blades is vertically moveable respectively into a selected printing position and a selected cutting position under control of a controller thereby accommodating a plurality of different cardboard sheets of different sizes.

2. The assembly of claim 1, wherein said printing station feeds the printed blank into said cutting station.

3. The assembly of claim 1, wherein said at least one printer heads is an inkjet printer.

4. The assembly of claim 1, wherein said upper and lower elongate slot cutting blades are aligned in an end to end configuration.

5. The assembly of claim 1, wherein said upper and lower elongate slot cutting blades are aligned in an end to end configuration.

6. The assembly of claim 1, wherein said cutting station further comprises a an elongate bar arranged vertically for creasing the cardboard sheet along a crease line aligned with the upper slot and lower slot.

7. The assembly of claim 1, wherein at least one of said at least one printer head is moveable vertically.

8. The assembly of claim 1, wherein the plurality of cardboard sheets have different thicknesses, and further wherein said at least one printer head is moveable horizontally under control of said controller to accommodate the different thicknesses of the cardboard sheets.

9. An assembly for printing substantially rigid cardboard sheets, comprising:
a feeder for vertically feeding one of a plurality of the cardboard sheets from a storage position into a printing station;
said printing station comprising a vertical conveyor for conveying a printing surface of the cardboard sheet proximate to a plurality of inkjet printer heads spaced vertically, wherein the printing surface is printed as the cardboard sheet is conveyed vertically adjacent the plurality of printer heads;
wherein each of said printer heads is vertically moveable respectively into a selected printing position under control of a controller thereby accommodating a plurality of different cardboard sheets of different sizes.

10. A vertically moveable large character printer assembly comprising:
a threaded shaft arranged vertically and rotatably secured at both ends;
an elongate stabilising member arranged adjacent and in parallel to said threaded rod;
a support comprising an aperture complementarily threaded for receiving said threaded shaft therein, wherein a rotary movement of said support is prevented by said stabilising member;
a large character printer head attached to said support and comprising a printing surface, wherein said printer head is aligned for printing a surface substantially in parallel to said shaft; and
a motor for rotating said threaded shaft in selected direction;
wherein when said shaft is rotated by said motor, said support is free to move up and down a length of said shaft in accordance with said selected direction of rotation.

11. The vertically moveable printer assembly of claim 10, wherein said printer head is a large character inkjet printer head.

12. The vertically moveable printer assembly of claim 10, wherein said support comprises a second aperture therein and further wherein said stabilising bar is inserted through said aperture.
